(19) United States
(12) Patent Application Publication
(10) Pub. No.: US 2006/0196315 A1
(43) Pub. Date: Sep. 7, 2006

(54) A COMBINATION DRILL CHUCK AND SOCKET WRENCH

(76) Inventor: Paul Teel, Granbury, TX (US)

Correspondence Address: WALTER J, TENCZA JR., 10 STATION PLACE, SUITE 3, METUCHEN, NJ, 08840, US

(21) Appl. No.: 11/306,130

(22) Filed: Dec. 16, 2005

(51) Int. Cl. B25B 13/44

(52) U.S. Cl. 81/16

(57) ABSTRACT

Abstract of the Disclosure

A socket portion, a chuck device, a handle device, and a central member fixed to the socket portion, chuck device, and the handle device are provided. The handle device can be used to turn the central member in a first direction about an axis while the central member remains stationary. When the handle device turns the central member in the first direction about the axis, the socket portion turns such that the socket portion can be used to exert torque on a fastener. In addition, when the handle device turns the central member in the first direction about the axis, the chuck device turns such that the chuck device can be used to exert torque on a drill bit holding device.

### Detailed Description of the Invention

### Field of the Invention

This invention relates to improved methods and apparatus concerning drill chucks and socket wrenches.

### Background of the Invention

Typically in the prior art a drill chuck is provided separately from a socket wrench.

### Summary of the Invention

In one embodiment of the present invention an apparatus is provided comprising a socket portion, a chuck device, a handle device, and a central member fixed to the socket portion, chuck device, and the handle device. The central member may have an axis. The handle device can be used to turn the central member in a first direction about the axis while the central member remains stationary. When the handle device turns the central member in the first direction about the axis, the socket portion turns such that the socket portion can be used to exert torque on a fastener. In addition, when the handle device turns the central member in the first direction about the axis, the chuck device turns such that the chuck device can be used to exert torque on a drill bit holding device.

The handle device may be comprised of a left member and a right member. Each of the left member and the right member may be fixed to the central member so that each of the left member and the right member is substantially perpendicular to the central member. The socket portion may be fixed at a first end of the central member and the chuck device may be fixed at a second end of the central member, wherein the first end is substantially opposite the second end. The central member may be metal, rigid, and substantially cylindrical.

In one embodiment of the present invention a method is provided including providing a socket portion, providing a chuck device, providing a handle device, and fixing a central member to the socket portion, chuck device, and the handle device.

### Brief Description of the Drawings

Fig. 1 shows a perspective view of an apparatus in accordance with an embodiment of the present invention;

Fig. 2 shows a front view of the apparatus of Fig. 1;

Fig. 3 shows a rear view of the apparatus of Fig. 1;

Fig. 4 shows a right side view of the apparatus of Fig. 1;

Fig. 5 shows a left side view of the apparatus of Fig. 1;

Fig. 6 shows a bottom view of the apparatus of Fig. 1; and

Fig. 7 shows a top view of the apparatus of Fig. 1.

### Detailed Description of the Drawings

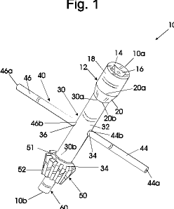

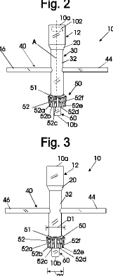

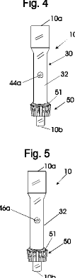

Fig. 1 shows a perspective view of an apparatus 10 in accordance with an embodiment of the present invention. Figs. 2-7 show front, rear, right side, left side, bottom, and top views, respectively of the apparatus 10 of Fig. 1.

Referring to Figs. 1-7, the apparatus 10 includes a socket portion 12, a member 30, a handle device 40, a chuck device 50, and a member 60.

The socket portion 12 may be a typical socket used for a socket wrench. The socket portion 12 may have a top surface 14, a cavity 16, a cylinder 18, and a section 20. The cavity 16 may be rectangular. A rectangular head of a nut or bolt can be inserted into the cavity 16. The section 20 may have an outer diameter, which gradually decreases from end 20a adjacent the cylinder 18 to end 20b adjacent the member 30.

The member 30 may be substantially cylindrical. The member 30 may rigid, metal, and hollow. The handle device 40 may be comprised of left member 46 and right member 44. Each of the left member 46 and the right member 44 may be substantially perpendicular to the member 30. Each of the left member 46 and the right member 44 may be substantially cylindrical, metal, rigid, and solid. The left member 46 may have a free end 46a and an end 46b, which is fixed to the member 30 through an opening 36. Similarly, the right member 44 may have a free end 44a and an end 44b, which is fixed to the member 30 through an opening 34.

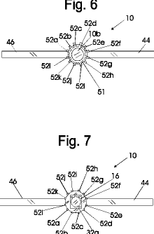

The chuck device 50 may include a plurality of ridges 52. The plurality of ridges 52 include ridges 52a, 52b, 52c, 52d, 52e, 52f, 52g, 52h, 52i52j, 52k, and 52l as shown by Figs. 6 and 7. The chuck device 50 can be used to tighten or loosen a drill bit holding device on a drill. The ridges 52a-52l may protrude out from a solid metal core 51 shown in Figs. 1-6. The ridges 52a-52l may slope inwards so that the overall outer diameter of the chuck device 50 may decrease from D1, shown in Fig. 3 to D2.

The member 60 may be fixed, substantially centrally, to the bottom of the chuck device 50. The member 60 may be rigid, substantially cylindrical, metal, and solid.

In operation the apparatus 10 can be used as a socket wrench or as a drill chuck. A rectangular nut or bolt head, such as 102 shown by dashed lines in Fig. 2, can be inserted into the cavity 16 of the socket portion 12 and then the apparatus 10 can be rotated with the member 30, or dashed line A through the center of the member 30, being the stationary axis for rotation. The apparatus 10 can be rotated so that the members 46 and 44 of the handle device 40 move about the axis A, clockwise or counter counterclockwise, while the member 30 is turned but remains stationary.

The end 10b of the apparatus 10 and the ridges 52a-52l can be applied to a drill chuck and the apparatus 10 rotated, about the axis A, so that the member 30 remains stationary in order to tighten a drill bit onto a drill bit holding device on a drill. The apparatus 10 can be rotated so that the members 46 and 44 of the handle device 40 move about the axis A, clockwise or counter counterclockwise, while the member 30 is turned but remains stationary.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention’s contribution to the art.

What is Claimed is:

1. An apparatus comprising:
a socket portion;
a chuck device;
a handle device; and
a central member fixed to the socket portion, chuck device, and the handle device; and
wherein the central member has an axis;
wherein the handle device can be used to turn the central member in a first direction about the axis while the central member remains stationary,
wherein when the handle device turns the central member in the first direction about the axis, the socket portion turns such that the socket portion can be used to exert torque on a fastener;
and wherein when the handle device turns the central member in the first direction about the axis, the chuck device turns such that the chuck device can be used to exert torque on a drill bit holding device.

2. The apparatus of claim 1 wherein
the handle device is comprised of a left member and a right member; and
wherein each of the left member and the right member is fixed to the central member so that each of the left member and the right member is substantially perpendicular to the central member.

3. The apparatus of claim 1 wherein
the socket portion is fixed at a first end of the central member and the chuck device is fixed at a second end of the central member, wherein the first end is substantially opposite the second end.

4. The apparatus of claim 3 wherein
the handle device is comprised of a left member and a right member; and
wherein each of the left member and the right member is fixed to the central member so that each of the left member and the right member is substantially perpendicular to the central member.

5. The apparatus of claim 1 wherein
the central member is substantially cylindrical.

6. The apparatus of claim 1 wherein
the central member is rigid.

7. A method comprising:
providing a socket portion;
providing a chuck device;
providing a handle device; and
fixing a central member to the socket portion, chuck device, and the handle device; and
wherein the central member has an axis;
wherein the handle device can be used to turn the central member in a first direction about the axis while the central member remains stationary,
wherein when the handle device turns the central member in the first direction about the axis, the socket portion turns such that the socket portion can be used to exert torque on a fastener;
and wherein when the handle device turns the central member in the first direction about the axis, the chuck device turns such that the chuck device can be used to exert torque on a drill bit holding device.

8. The method of claim 7 wherein
the handle device is comprised of a left member and a right member; and
and further comprising fixing the left member and the right member to the central member so that each of the left member and the right member is substantially perpendicular to the central member.

9. The method of claim 7 further comprising
fixing the socket portion at a first end of the central member and the chuck device at a second end of the central member, wherein the first end is substantially opposite the second end.

10. The method of claim 9 wherein
the handle device is comprised of a left member and a right member; and
further comprising fixing the left member and the right member to the central member so that each of the left member and the right member is substantially perpendicular to the central member.

11. The method of claim 7 wherein
the central member is substantially cylindrical.

12. The method of claim 7 wherein
the central member is rigid.
